(19) United States
(12) Patent Application Publication
(10) Pub. No.: US 2015/0259208 A1
(43) Pub. Date: Sep. 17, 2015

(54) Method of Making Active Materials for Use in Secondary Electrochemical Cells

(71) Applicant: Titus Faulkner, Las Vegas, NV (US)

(72) Inventor: Titus Faulkner, Las Vegas, NV (US)

(73) Assignee: Valence Technology, Inc., Las Vegas, NV (US)

(21) Appl. No.: 14/213,877

(22) Filed: Mar. 14, 2014

(51) Int. Cl. C01B 25/45; H01M 4/58

(52) U.S. Cl. CPC C01B 25/45; H01M 4/5825; C01P 2006/40

(57) ABSTRACT

The present invention provides a method for producing lithium iron phosphate or lithium iron mixed metal phosphate. The method comprises using waste pickling liquor as a starting material wherein the waste pickling liquor is the source of the iron ions in such phosphates. The waste pickling liquor is mixed with lithium hydrogen phosphate, and optionally a source of at least one metal ion. The precipitate is then dried or filtered and calcined to produce a lithium iron phosphate or a lithium iron mixed metal phosphate.

### FIELD OF THE INVENTION

The present invention relates to the synthesis of electroactive lithium iron phosphate materials or lithium iron mixed metal phosphates for use in electrodes, more specifically for use as cathode active materials in lithium ion batteries.

### BACKGROUND OF THE INVENTION

A wide variety of electrochemical cells or batteries are known in the art. In general, batteries are devices that convert chemical energy into electrical energy, by means of an electrochemical oxidation-reduction reaction. Batteries are used in a wide variety of applications, particularly as a power source for devices that cannot practicably be powered by centralized power generation sources (e.g., by commercial power plants using utility transition lines).

Batteries can generally be described as comprising three components: an anode that contains a material that is oxidized (yields electrons) during discharge of the battery; a cathode that contains a material that is reduced (accepts electrons) during discharge of the battery; and an electrolyte that provides for transfer of ions between the cathode and anode. Batteries can be more specifically characterized by the specific materials that make up each of these three components. Selection of these components can yield batteries having specific voltage and discharge characteristics that can be optimized for particular applications.

The electrodes of such batteries generally include an electroactive material. Recently a class of transition metal phosphates and mixed metal phosphates have been developed for use as electroactive material. These transition metal phosphates and mixed metal phosphates are insertion based compounds and allow great flexibility in the design of lithium ion batteries. These phosphate compounds have a crystal lattice structure or framework from which ions, such as lithium ions, can be extracted and subsequently reinserted and/or from which ions such as lithium ions can be inserted or intercalated and subsequently extracted.

A class of such materials is disclosed in U.S. Pat. No. 6,528,033 B1 (Barker et al.). The compounds therein are of the general formula LiₐMI_{b}MII_{c}(PO₄)_{d} wherein MI and MII are the same or different. MI is a metal selected from the group consisting of Fe, Co, Ni, Mn, Cu, V, Sn, Cr and mixtures thereof. MII is optionally present, but when present is a metal selected from the group consisting of Mg, Ca, Zn, Sr, Pb, Cd, Sn, Ba, Be and mixtures thereof. U.S. Pat. No. 6,528,033 B1 (Barker et al.) further discloses useful electroactive materials of the formulae LiFePO₄ and LiFe₁₋ₓMgₓPO₄.

In general, such an electroactive material must exhibit a low free energy of reaction with lithium, be able to intercalate a large quantity of lithium, maintain its lattice structure upon insertion and extraction of lithium, allow rapid diffusion of lithium, afford good electrical conductivity, not be significantly soluble in the electrolyte system of the battery, and be readily and economically produced. However, many of the electroactive materials known in the art lack one or more of these characteristics.

It would be desirable and beneficial to have a process for preparing such intercalation materials at a reduced cost. The inventor of the present invention has now found an economical method for producing lithium iron phosphates or lithium iron mixed metal phosphates for use in the production of electrodes and in particular in the production of cathodes.

### SUMMARY OF THE INVENTION

The present invention provides a method for producing lithium iron phosphate or lithium iron mixed metal phosphate. The method comprises using waste pickling liquor as a starting material wherein the waste pickling liquor is the source of the iron ions in such phosphates. The waste pickling liquor is mixed with lithium hydrogen phosphate, and optionally a source of at least one metal ion. The precipitate is then dried or filtered and calcined to produce a lithium iron phosphate or a lithium iron mixed metal phosphate.

The synthesis of lithium iron phosphates or lithium iron mixed metal phosphates require at least one iron containing precursor as a starting material. Currently, in the lithium iron phosphate industry commercially available iron containing precursors such as, for example Fe₂O₃ or iron oxalate are used in the synthesis. Using an iron source that is the waste product of another commercial process would be more economical than using the commercially available iron precursors.

### DETAILED DESCRIPTION OF THE INVENTION

Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

A wide variety of commercially useful electroactive active materials are disclosed and may be made by the carbothermal processes described in U.S. Pat. No. 6,528,033; U.S. Pat. No. 6,716,372; U.S. Pat. No. 6,702,961; U.S. Pat. No. 6,913,855; U.S. Pat. No. 6,730,281 and U.S. Pat. No. 7,060,206. Electroactive material are materials which find use in the manufacture of electrodes, namely, cathodes and anodes. Such cathodes and anodes are then used in the production of electrochemical cells. In general, the useful electroactive materials are prepared by mixing a source of metal ion, a source of alkali metal ion, a source of phosphate, a source of carbon and optionally a source of a second metal ion. Such mixture is then heated in an inert atmosphere. For example, it has been disclosed that LiFe₁₋ₓMgₓPO₄ (lithium iron magnesium phosphate) can be prepared by mixing the reactants LiH₂PO₄, Fe₂O₃, Mg(OH)₂ and carbon and heating said reaction mixture in an inert atmosphere.

The present invention provides a method for producing lithium iron phosphate or lithium iron mixed metal phosphate. The method comprises using waste pickling liquor as a starting material wherein the waste pickling liquor is the source of the iron ions in such phosphates. The waste pickling mixture liquor is mixed with lithium hydrogen phosphate, and optionally a source of at least one metal ion. The precipitate is then dried or filtered and calcined to produce a lithium iron phosphate or a lithium iron mixed metal phosphate. Such phosphates are electroactive materials that in their final form find use in making electrodes

Iron and steel processing industries produce iron and steel parts by treating the iron or steel with hydrochloric acid or sulfuric acid to remove the oxide layer (FeO) from the surface before any further processing (e.g. electroplating, metal finishing) of the iron or steel part. This process called pickling generates (spent) waste pickling liquor containing an iron concentration. The pickling liquor contains mainly ferrous chloride (FeCl₂) and a few percent acid or ferrous sulfate (FeSO₄) and a few percent acid. The ferrous chloride and ferrous sulfate are generated by the following general reactions:

FeO+2HCl→FeCl₂+H₂O (I)

FeO+H₂SO₄→FeSO₄+H₂O. (II)

The spent pickling liquor generally contains 2-7 percent free acid and 5-15 percent ferrous iron. When pickling liquor is periodically discarded there is a high concentration of iron (70 to 100 g/L) in it. Given the volume of steel produced annually and the necessity of disposing of the waste pickling liquor, spent pickling liquor represent an ideal iron containing precursor that is available at very high volume and at low or no cost.

In a preferred embodiment the process of the present invention is a one step process represented for example by the following reaction:

xFeCl₂+(1−x)MgCl₂+LiH₃PO₄→LiHFeₓMg₁₋ₓPO₄+2HCl (III)

In general the waste pickling liquor is mixed with lithium hydrogen phosphate (LHP) and optionally additional metal ions to form a lithium iron phosphate or lithium mixed metal phosphate. The lithium iron phosphate or lithium iron mixed metal phosphate so formed is then dried or filtered and calcined. In the above reaction (III) the FeCl₂ represents the iron in the waste pickling liquor which is mixed with magnesium chloride and LHP to produce a lithium iron magnesium phosphate. Lithium iron phosphate can be formed according to the above reaction by elimination of the addition of magnesium chloride.

In another preferred embodiment the process of the present invention is a two step process represented for example by the following reactions:

3FeCl₂+2H₃PO₄→Fe₃(PO₄)₂+nH₂O+6HCl (IV)

xFe₃(PO₄)₂+((1−x)Mg₃(PO₄)₂+Li₃PO₄→3LiFeₓMg₍₁₋ₓ₎PO₄ (V)

In general the waste pickling liquor is mixed with hydrogen phosphate to form a ferrous phosphate. The ferrous phosphate so formed is then mixed with a source of lithium (such as lithium phosphate) and optionally a source of at least one addition metal ion (such as magnesium phosphate) to form lithium iron phosphate or lithium iron mixed metal phosphate. The phosphate so formed is then dried or filtered and calcined. In the above reaction (III) the FeCl₂ represents the iron in the waste pickling liquor. Lithium iron phosphate can be formed according to the above reaction by elimination of the addition of magnesium chloride.

In general in the one step process the waste pickling liquor is mixed with lithium salt and a phosphate salt or a lithium phosphate compound (such as lithium hydrogen phosphate) and optionally additional metal ions to form a lithium iron phosphate or lithium mixed metal phosphate. The lithium iron phosphate or lithium iron mixed metal phosphate so formed is then dried or filtered and calcined.

In general, in the two step process the waste pickling liquor is mixed with ammonium hydrogen phosphate to form a ferrous phosphate. The ferrous phosphate so formed is then mixed with a source of lithium (such as lithium phosphate or lithium carbonate) and optionally a source of at least one addition metal ion (such as magnesium phosphate) to form lithium iron phosphate or lithium iron mixed metal phosphate. The phosphate so formed is then dried or filtered and calcined. In the above reaction (III) the FeCl₂ represents the iron in the waste pickling liquor.

In one aspect, the electroactive materials prepared by the process of the present invention are lithium metal phosphates or lithium mixed metal phosphates of general formula

LiFe₍₍₁₋ₓ₎MₓPO₄

wherein M s selected from the group consisting of Mg, Ca, Zn, Sr, Pb, Cd, Sn, Ba, Be, Al, and mixtures thereof; more preferably M is selected from the group consisting of Mg, Ca, Zn, Ba, Al, and mixtures thereof, most preferably M is Mg and x is greater than or equal to about 0.01 and less than or equal to about 0.15.

Sources of metals M include salts or compounds of metals such as aluminum, magnesium tin, lead, zinc, strontium, barium, cadmium and beryllium. The metal compounds include, without limitation, fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, oxalates, and the like. Hydrates may also be used, as well as mixtures of metals, as with the alkali metals, so that alkali metal mixed metal active materials are produced.

Sources of phosphate include lithium hydrogen phosphate, lithium phosphate, hydrogen ammonium phosphate, or dihydrogen ammonium phosphate. Hydrates of any of the above may be used, as can mixtures of the above. Other sources of phosphate, include the acids, which are usually available in a liquid form as either the pure compound or a concentrated aqueous solution. A preferred phosphate source, for example, is concentrated orthophosphoric acid, available as approximately an 85% by weight solution in water.

A starting material may provide more than one of the components Li, M, and PO₄. In various embodiments of the invention, starting materials are provided that combine, for example, the metal and the phosphate or the lithium and the phosphate. There is complete flexibility to select starting materials containing any of the components of Li, metal M, phosphate.

Removal of water from the materials of the present invention can be achieved by conventional methods known in the art. For “two-step” precursors, the metal phosphate formed by addition of phosphate to waste pickling liquor will be a solid. This solid may be separated from solution by filtration or centrifuging. The act of separation eliminates the chloride or sulphate ions which mostly stay in the solution. The wet cake thus derived may be dried by various paste drying techniques, preferably spin flash drying or band drying. The lithium precursor may be added by paste blending before drying the wet cake or by powder blending after drying the wet cake.

For “one-step” precursors, the stickiness of metal chloride and metal sulphate precursors restricts drying and calcining methods to a limited range of options. One means to dry a sticky substance is to blend it with a significant quantity of the already dried substance thus rendering the mixture less sticky and allowing drying to occur without excessive sticking. This requires recycling of dried material within the drying process in order to blend it with a small amount of wet material to form a damp powder. The resulting damp powder may be dried by any means suitable for powder drying such as fluidized bed, rotary, flash or spin flash drying.

Another means to dry a sticky substance is to roast it as it falls through free space, in order to remove chloride or sulphate ions that make it sticky. This requires application of high temperatures in a spray roaster. Conductive additives such as carbon black, or organic materials that produce carbon in-situ during calcining may be added after roasting by blending with the roasted powder.

Calcining of the materials of the present invention can be achieved by conventional methods know in the art. Calcining may be done in a static bed furnace, rotary kiln or pusher kiln. If significant chloride or sulphate is present in the precursor before calcination, the calciner must be outfitted to tolerate and process the gaseous decomposition products of said ions.

The term “calcined” includes but is not limited to “thermally processed,” and “reacted.” Such calcination may be carried out at temperature between 650° C. to 750° C., preferably at 700° C. Such calcination may be carried out for time between 30 minutes and 8 hours, preferably between 2 hours and 4 hours.

The materials produced by the process of the present invention find use in producing electrodes comprising an electrode active material made by the process of the present invention. In a preferred embodiment, the electrodes of the present invention comprise an electrode active material made by the process of this invention, a binder; and an electrically conductive carbonaceous material.

In a preferred embodiment, the electrodes of this invention comprise:
i. from about 25% to about 95%, more preferably from about 50% to about 90%, electroactive material;
ii. from about 2% to about 95% electrically conductive material (e.g., carbon black); and
iii. from about 3% to about 20% binder chosen to hold all particulate materials in contact with one another without degrading ionic conductivity.
   (Unless stated otherwise, all percentages herein are by weight.) Cathodes of this invention preferably comprise from about 50% to about 90% of electroactive material, about 5% to about 30% of the electrically conductive material, and the balance comprising binder. Anodes of this invention preferably comprise from about 50% to about 98% by weight of the electrochemically active material (e.g., a preferred graphite), from 0% to about 5% electrically conductive additive with the balance comprising binder.

Electrically conductive materials among those useful herein include carbon black, graphite, powdered nickel, metal particles, conductive polymers (e.g., characterized by a conjugated network of double bonds like polypyrrole and polyacetylene), and mixtures thereof. Binders useful herein preferably comprise a polymeric material and extractable plasticizer suitable for forming a bound porous composite.

In a preferred process for making an electrode, the electrode active material is mixed into a slurry with a polymeric binder compound, a solvent, a plasticizer, and optionally the electroconductive material. The active material slurry is appropriately agitated, and then thinly applied to a substrate via a doctor blade. The substrate can be a removable substrate or a functional substrate, such as a current collector (for example, a metallic grid or mesh layer) attached to one side of the electrode film. In one embodiment, heat or radiation is applied to evaporate the solvent from the electrode film, leaving a solid residue. The electrode film is further consolidated, where heat and pressure are applied to the film to sinter and calendar it. In another embodiment, the film may be air-dried at moderate temperature to yield self-supporting films of copolymer composition. If the substrate is of a removable type it is removed from the electrode film, and further laminated to a current collector. With either type of substrate it may be necessary to extract the remaining plasticizer prior to incorporation into the battery cell.

The following non-limiting examples illustrate the compositions and methods of the present invention.

### Example 1

### Preparation of LiFe_{0.95}Mg_{0.05}PO₄—One Step Process

(1) FeCl₂ contained in waste pickling liquor, magnesium chloride, and lithium hydrogen phosphate are mixed together in the ratio
0.95 moles FeCl₂
0.05 moles MgCl₂
1.00 moles LiH₂PO₄
   (2) The mixture is spray roasted in air with inlet temperature of 700° C., producing a dry powder which is separated from the roaster exhaust gas.
   (3) The dry powder is then blended with carbon black at a ratio of 2.57 mole per mole of iron using a ball mill.
   (4) The powder is pressed into a pellet and calcined at 750° C. for 4 hours.

### EXAMPLE 2

### Preparation of LiFe_{0.95}Mg_{0.05}PO₄ Two Step Process

(1) FeCl₂ in waste pickling liquor, (NH₄)₂HPO₄, aqueous ammonia and carbon black are mixed in solution to form ferrous phosphate precipitate in the ratio
0.95 moles FeCl₂
0.67 moles (NH₄)₂HPO₄
0.28 moles NH₄OH
2.57 moles C
   (2) The precipitate that forms is separated from solution by vacuum filtration on a glass fiber filter, then dried to cake in a laboratory drying oven and crushed to powder in a mortar and pestle
   (3) This ferrous phosphate powder is blended with Mg(OH)₂ and Li₃PO₄ in the molar ratio (0.95:0.05:0.33) (Fe:Mg(OH)_{2:}Li₃PO₄)
   (4) The blended powder is pressed into a pellet and calcined at 750° C. for 4 hours

What is claimed is:

1. A method for making a lithium iron phosphate or lithium iron mixed metal phosphate electroactive material comprising:
using waste pickling liquor as a starting material wherein the waste pickling liquor is the source of the iron.

2. The method of claim 1 wherein LHP is added to the waste pickling liquor to produce an iron phosphate intermediate.

3. The method of claim 2 wherein the iron phosphate intermediate is dried or filtered and calcined to produce a lithium iron phosphate.

4. The method of claim 1 wherein LHP and a source of at least one other metal ion is added to the waste pickling liquor to produce an iron phosphate intermediate.

5. The method according to claim 4 wherein the iron phosphate intermediate is dried and calcined to produce a lithium iron mixed metal phosphate.

6. The method according to claim 4 wherein the source of the at least one other metal ion is MgCl₂.

7. The method according to claim 6 wherein the iron phosphate intermediate is dried or filtered and calcined to produce a lithium metal phosphate of the nominal general formula LiFe₍₁₋ₓ₎MₓPO₄ wherein x is less than or equal to about 0.15 and greater than or equal to about 0.01 and M is at least one metal ion selected from the group consisting of Mg, Ca, Zn, Sr, Pb, Cd, Sn, Ba, Be, Al and mixtures thereof

8. The method according to claim 7 wherein the lithium metal phosphate is of the nominal general formula LiFe₍₁₋ₓ₎MgₓPO₄ wherein x is less than or equal to about 0.15 and greater than or equal to about 0.01

9. The method according to claim 5 wherein the lithium mixed metal phosphate is of the nominal general formula:
LiFe₍₍₁₋ₓ₎MₓPO₄
wherein M is selected from the group consisting of Mg, Ca, Zn, Ba, Al, and mixtures thereof, and x is greater than or equal to about 0.01 and less than or equal to about 0.15

10. The method according to claim 3 wherein the lithium metal phosphate is of the nominal general formula
LiFePO₄.

11. The method according to claim 8 wherein the lithium metal phosphate is of the nominal general formula LiFe_{0.95}Mg_{0.95}PO₄.
